(19) United States
(12) Patent Application Publication
(10) Pub. No.: US 2018/0052267 A1
(43) Pub. Date: Feb. 22, 2018

(54) Polarized Lenses Obtained by the Lamination of a Polarized Film

(71) Applicant: ESSILOR INTERNATIONAL (COMPAGNIE GENERAL D'OPTIQUE), Charenton-le-Pont (FR)

(72) Inventors: Neil ROCHE, Dallas, TX (US); John BITEAU, Dallas, TX (US); Timothy HEROD, Dallas, TX (US); Stefan SETZ, Dallas, TX (US)

(21) Appl. No.: 15/561,253

(22) PCT Filed: Mar. 25, 2015
(86) PCT No.: PCT/IB2015/000498

§ 371 Date: Sep. 25, 2017

(51) Int. Cl. G02B 5/30; G02B 1/14; B32B 23/04; B32B 27/30

(52) U.S. Cl. CPC G02B 5/305; G02B 1/14; B32B 2307/42; B32B 27/30; B32B 23/04

(57) ABSTRACT

The present invention relates to optical articles coupled to polarized laminate films. Optic properties, production methods, and compositions of component film layers were examined. Film layer criteria were selected that results in laminate films with particular optic properties. Lamination of optical elements with the inventive laminate films results in improved transmission and clarity through the optical elements.

### FIELD OF THE INVENTION

This invention relates to optical articles coupled to laminate films. More specifically, the invention relates to optical articles coupled to polarized laminate films with particular optical properties, resulting in improved transmission and clarity through the optical article.

### BACKGROUND

Polarizing films are optical filters that limit the total amount of light that passes through the film. A number of methods are available for integrating a polarizing layer with an optical article to produce a polarized optical article. In a casting process, a polarizing film is placed in a mold, it is then encapsulated within a monomer, which is then polymerized to a final state. The resulting optical quality is dependent upon the casting mold quality. However there are manufacturing difficulties associated with making polarizing cast lenses with optimum refractive index values. Additional disadvantages of the casting process include a high minimum lens thickness, film movement during processing, non-uniform polarization efficiency, and difficulty with properly placing a film in a non-planar assembly.

In an injection molding process, a polarizing film is placed into the front side of an injection cavity, and transparent thermoplastic is injected against the polarizing film. One disadvantage of the injection molding process is that polarizing dyes and films used in the process are often temperature sensitive. The temperature sensitivity of the polarizing agent can lead to defects resulting in non-uniformity and impaired optical quality. A second disadvantage of the injection molding process is that the injected raw lens material is limited to thermoplastic polymers.

A third optical article polarization process involves the application of a polarizing coating. In a polarizing coating process, an alignment surface is created on an optical article. This may be accomplished by mechanically rubbing the surface or by depositing an alignment coating. A guest-host dichroic dye/liquid crystal composition is deposited on the optical article surface, and the dichroic dye alignment is locked in. The locking-in process may be accomplished by a number of methods, including drying and polymerization. The resulting optical article quality depends upon the starting surface quality of the optical article and the uniformity of the coating composition. One disadvantage associated with the dichroic dye polarizing coating process is low polarization efficiency, which can be limited by the coating thickness. Further, because the polarizing coating is applied independently, it is not protected by a thick (>40 μm) polymeric protective layer and is subject to scratches, which can lead to deterioration.

There is a need in the industry for producing optical articles such as polarizing glasses and liquid crystal displays, composites, and lenses or sheets laminated on polarizing film by a polarization process that combines high, uniform polarization efficiency, high optical quality, and resistance to wear/deterioration.

### SUMMARY

A lamination process disclosed herein involves applying a laminated polarized film to an optical article and offers advantages not presented by the aforementioned techniques. Lamination processes are not limited to a particular substrate, e.g., thermoplastics. Lamination processes confer especially uniform polarization efficiency, and allow for the production of very thin optical articles. When polar polyvinyl alcohol (PVA) films are used, the polarization efficiency is remarkably high. It is therefore an object of the present invention to provide a set of criteria for a lamination process which results in exceptional optic quality of laminated optical articles.

In some aspects, the present invention provides an article comprising at least one outer surface, wherein the at least one outer surface comprises a film. The film comprises less than 500 features/mm² of micron-scale features, a maximum thickness variation of 1 μm, and maximum slope of 0.05 μm/mm. In particular embodiments, the article is an optical article. Optical devices, optical elements, ophthalmic elements, ophthalmic lenses, polarized lenses, polarizing lenses, laminated lenses, laminated bodies, functional laminates, light control devices, molded articles, molded optical articles, and molded products are contemplated by the invention. In some embodiments, the film further comprises short scale variations in the z-direction of less than 0.5 μm.

In particular embodiments the film comprises an American Society for Testing and Materials (ASTM) haze of less than 0.5%. In further embodiments, the article comprises less than 300 features/mm² of micron-scale features. In some aspects of the invention, a film with a maximum thickness variation of 0.5 μm is provided. The root mean square (RMS) of thickness variation is less than 100, in some aspects. In some embodiments of the invention, the film comprises short scale variations in the z-direction of less than 0.3 μm. In particular embodiments of the invention, the RMS of short scale variation is less than 250. In additional embodiments, the film comprises an ASTM haze of less than 0.3%.

Certain embodiments of the invention are directed to multi-layer laminate films. The multi-layer laminate film may further comprise at least one polarizing film layer. In a particular embodiment, the at least one polarizing film layer comprises PVA. A polarizing film layer used for embodiments of the present invention may be formed by stretching a thin film of e.g., polyvinyl alcohol, and dyeing the stretched film with iodine or other dichroic dyes known to those of skill in the art. In certain aspects of the invention, a multi-layer laminate film comprises at least one layer of triacetyl cellulose (TAC) film. Particular embodiments of the invention comprise at least one polarizing film layer laminated between layers of triacetyl cellulose film. The polarizing film layer thickness may range from 1 μm to 100 μm. The at least one TAC film layer thickness may range from 1 μm to 200 μm. In some embodiments, the polarizing film layer thickness is greater than the thickness of at least one TAC film layer. In other embodiments, the polarizing film layer thickness is less than the thickness of at least one TAC film layer. In further embodiments, the polarizing film layer thickness is equal to the thickness of at least one TAC film layer. The TAC film is a polymeric film where all or a predominant portion of the film is composed of triacetyl cellulose. Any known sources or additives may be used in the film. Other esterified cellulose films are contemplated. Cellulose may be esterified using fatty acids such as propanoic acid, butyric acid, valeric acid, or a number of other alkyl or functionalized-alkyl fatty acids.

The laminate films of the invention may further comprise at least one protective film layer on at least one outer surface. The protective film layer may comprise polyethylene, ethyl vinyl acetate (EVA), a combination of polyethylene and EVA, or any polymer, copolymer or combination of polymers known to those of skill in the art. Additional protective film layer materials include cellulose acetate butyrate, poly(n-butyl methacrylate), poly(isobutyl methacrylate), poly(methyl methacrylate), poly(ethyl methacrylate), polyethylene, polypropylene, poly(acrylonitrile), poly(vinyl acetate), poly(vinyl chloride), poly(butadiene), and polyimide.

The thickness of the protective film layer or layers may range from 1 μm to 100 μm. In some embodiments, the thickness of the protective film layer or layers is greater than the thickness of at least one TAC film layer. In other embodiments, the thickness of the protective film layer or layers is less than the thickness of at least one TAC film layer. In further embodiments, the thickness of the protective film layer or layers is equal to the thickness of at least one TAC film layer. In some embodiments, the multi-layer laminate film is a TAC/PVA/TAC film.

In some embodiments, a laminate film is located on a convex side of an optical article. In other embodiments, a laminate film is located on a concave side of an optical article. In further embodiments, optical articles of the invention comprise a film on both a concave and a convex side of the optical article. Particular aspects of the invention are directed towards a film with micron-scale features that measure from about 0.1 to about 0.5 μm in the z-direction. In additional embodiments, the micron-scale features measure from about 2 μm to about 5 μm in diameter. Short scale variations are variations separated in the x-y plane by from about 2 mm to about 5 mm. The medium scale variations are variations separated in the x-y plane by from about 1 cm to about 2 cm.

In further embodiments, the present invention provides an article obtained by applying a film to at least one outer surface of the article, the film comprising: less than 500 features/mm² of micron-scale features, and a maximum thickness variation of 1 μm and maximum slope of 0.05 μm/mm.

The optical elements of the present invention may include lenses, optical lenses, ophthalmic lenses, spectacle lenses, sunglass lenses, goggles, transparent plastic products, including windows for construction, windows for motor vehicles, glasses for viewing three-dimensional motion pictures, cameras, strain gauges, liquid crystal displays, TV and other display monitors, and illumination adjusting windows, for example.

The term “coupled” is defined as connected, although not necessarily directly, and not necessarily mechanically. The terms “a” and “an” are defined as one or more unless this disclosure explicitly requires otherwise. The term “substantially” is defined as being largely but not necessarily wholly what is specified (and include wholly what is specified) as understood by one of ordinary skill in the art. In any disclosed embodiment, the term “substantially” may be substituted with “within [a percentage] of” what is specified, where the percentage includes 0.1, 0.2, 0.3, 0.4, 0.5, 0.6, 0.7, 0.8, 0.9, 1, 2, 3, 4, 5, 6, 7, 8, 9, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, for example, a film that “comprises,” “has,” “includes” or “contains” one or more elements possesses those one or more elements, but is not limited to possessing only those one or more elements. Likewise, an element of a system or composition that “comprises,” “has,” “includes,” or “contains” one or more features possesses those one or more features, but is not limited to possessing only those one or more features.

Furthermore, a structure or composition that is configured in a certain way is configured in at least that way, but may also be configured in ways that are not listed, Metric units may be derived from the English units provided by applying a conversion and rounding to the nearest millimeter. The feature or features of one embodiment may be applied to other embodiments, even though not described or illustrated, unless expressly prohibited by this disclosure or the nature of the embodiments.

Any embodiment of any of the disclosed compositions and/or methods can consist of or consist essentially of—rather than comprise/include/contain/have—any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

### BRIEF DESCRIPTION OF THE DRAWINGS

The following drawings illustrate by way of example and not limitation.

FIG. 1 is an illustration of an exemplary TAC/PVA/TAC polarizing film used in the polar 1.74 lens.

FIG. 2 is a table describing film variabilities of different scales.

FIGS. 3A-D are optical microscopy and White Light Interferometer (WLI) images of different films. FIGS. 3A and 3C are optical microscopy and WLI images, respectively, of film X2. FIGS. 3B and 3D are optical microscopy and WLI images, respectively, of film Y2.

FIGS. 4A-C are WLI images of films X2, Y2, and Y4.

FIG. 4D is a table comparing ASTM Haze %, features/mm², and roughness for the three films.

FIGS. 5A and 5B are visual observations of TAC films viewed through a Transmission Arc Lamp. The film in FIG. 5A appears uniform, whereas the film in FIG. 5B contains film thickness variations that are visible to the naked eye.

FIGS. 6A and 6B are monochromatic light reflection images of two different TAC films, Z3 and X4.

FIG. 6C is a graph illustrating filmetrics measurements taken from the films X4 and Z3 at the indicated positions that show the magnitude of the film thickness variation.

FIGS. 7A and 7B are images of films Z2 and Y4. The vertical bars to the left of each image illustrate the different scales of the measured wave aberrations. The wave aberrations are a function of the degree of film thickness variability. Film Z2 ranges from 255 nm to 291 nm. Film Y4 ranges from −368 nm to 645 nm.

FIG. 7C is a table listing peak to valley measurements for films Z2 and Y5, and RMS values of the PV measurements.

FIG. 8A is an image of “golf ball” defects seen on a laminated lens through an arc lamp.

FIG. 8B is an image of a formed wafer showing golf ball defects.

FIG. 9 is an illustration of DLM points of measure.

### DETAILED DESCRIPTION

Various features and advantageous details are explained more fully with reference to the non-limiting embodiments that are illustrated in the accompanying drawings and detailed in the following description. It should be understood, however, that the detailed description and the specific examples, while indicating embodiments of the invention, are given by way of illustration only, and not by way of limitation. Various substitutions, modifications, additions, and/or rearrangements will be apparent to those of ordinary skill in the art from this disclosure.

In the following description, numerous specific details are provided to provide a thorough understanding of the disclosed embodiments. One of ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

### EXAMPLES

It has been found that the lamination of optical articles with polarized laminate films of defined optical properties results in improved transmission and clarity through the optical article. Optical analysis of composite laminate film layers was performed in order to identify advantageous film layer optics, materials, and production processes. The exemplary film laminate described herein comprises five layers, however laminate films of the invention may comprise any integer number of layers.

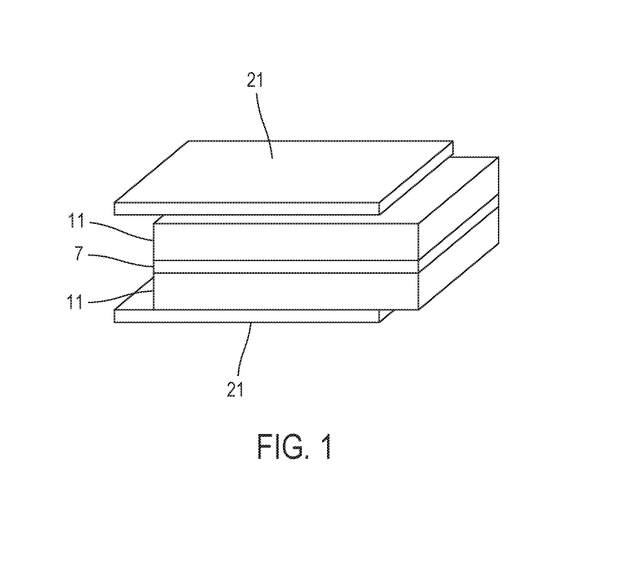

FIG. 1 illustrates an exemplary laminate film made of five layers with a polarizing layer 7 of polyvinyl alcohol (PVA) sandwiched between two layers 11 of triacetate (TAC) film and protective liners 21 that are comprised of polyethylene/EVA and are overlaid on the TAC layers 11. In one embodiment, the TAC film layer can be about 60 μm in thickness. The PVA polarizer layer can be about 30-40 μm in thickness. The particular film layer compositions are selected for illustrative purposes, and other film compositions used in the art may be selected for each of the different film layers. The desired optical properties may be ascribed to film compositions other than the ones used in the exemplary film laminate examined below.

The following key characteristics were identified (examining instruments identified in parentheses): Surface Granularity (Ambios Technologies Xi1.00 White Light Interferometer, WLI); Laminate Film Thickness Variation or Surface Waviness (Filmetrics reflectance spectrometer and a monochromatic light reflection imaging device); Haze and % Transmission (HazeGard Transparency Meter).

A. Optics Measurements

SR2: Sphere and cylinder in diopters were determined from radius of curvature measurements taken at the center point (PRP) of what? and at (15, 0) and (0, 15) millimeters using an Automation & Robotics SR2. Dual Lens Mapper (DLM): Error mapping calculations were performed using an Automation & Robotics Dual Lens Mapper.

1. Film Variability

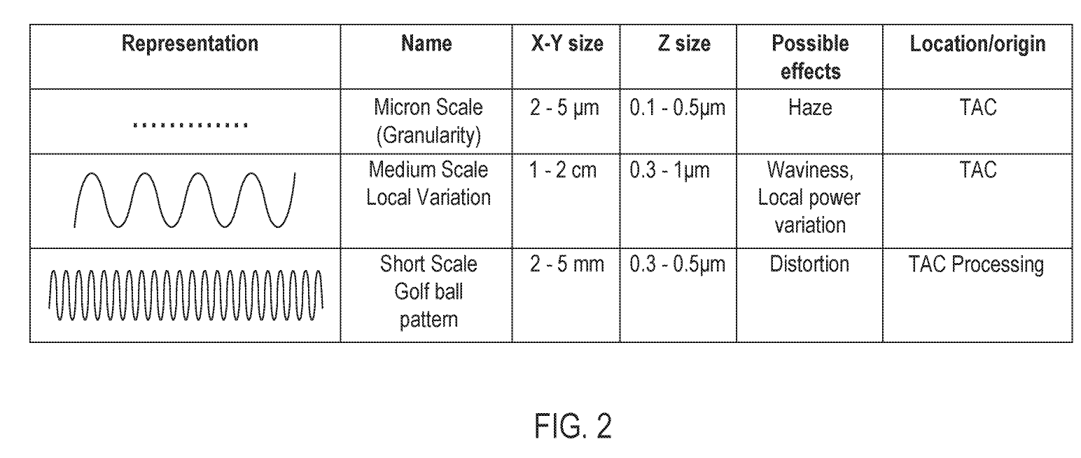

Thickness variability of a film layer or a film laminate may lead to inconsistencies and increased dispersion of the laminated lens optics measurements. These film variations exist on various scales. Micron, medium, and short scale variations are described in FIG. 2.

2. Micron Scale Variations

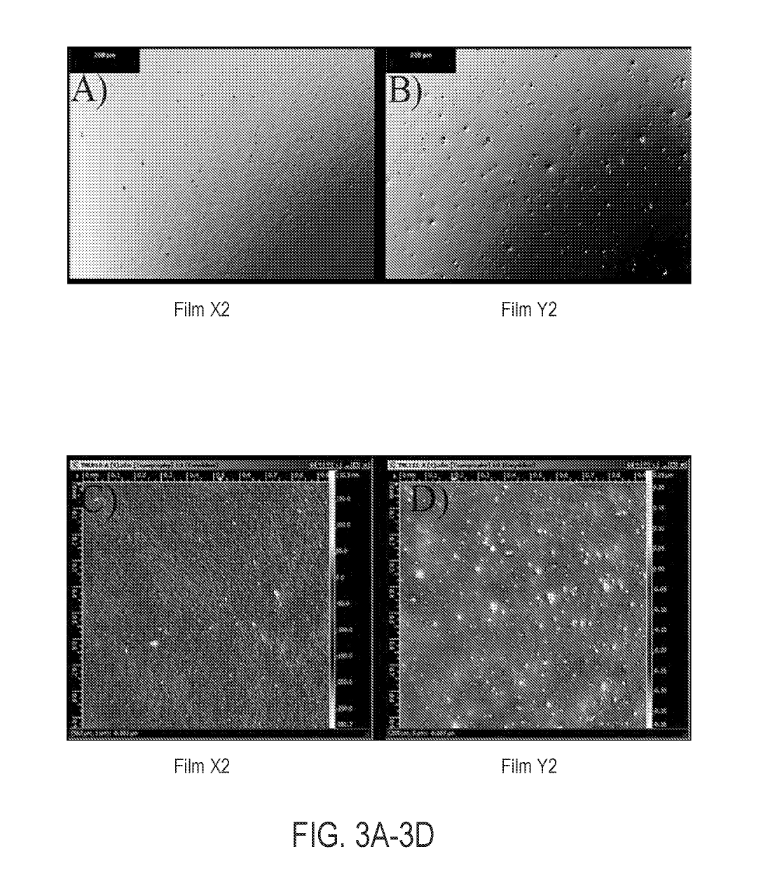

Analysis of different TAC film grades was performed in order to identify the grade that provided superior optics. TN (twisted nematic) and TF (thin film transistor) TAC film grade surfaces were compared using optical microscopy (FIGS. 3A and 3B) and WLI (FIGS. 3C and 3D). The TN type of film showed significantly more particles on the film surface (FIGS. 3B and 3D) than the TF type film (FIGS. 3A and 3C). Laminated lenses made with the TN type of TAC were unreadable with the SR2 and showed high levels of haze with the HazeGard Transparency Meter (data not shown).

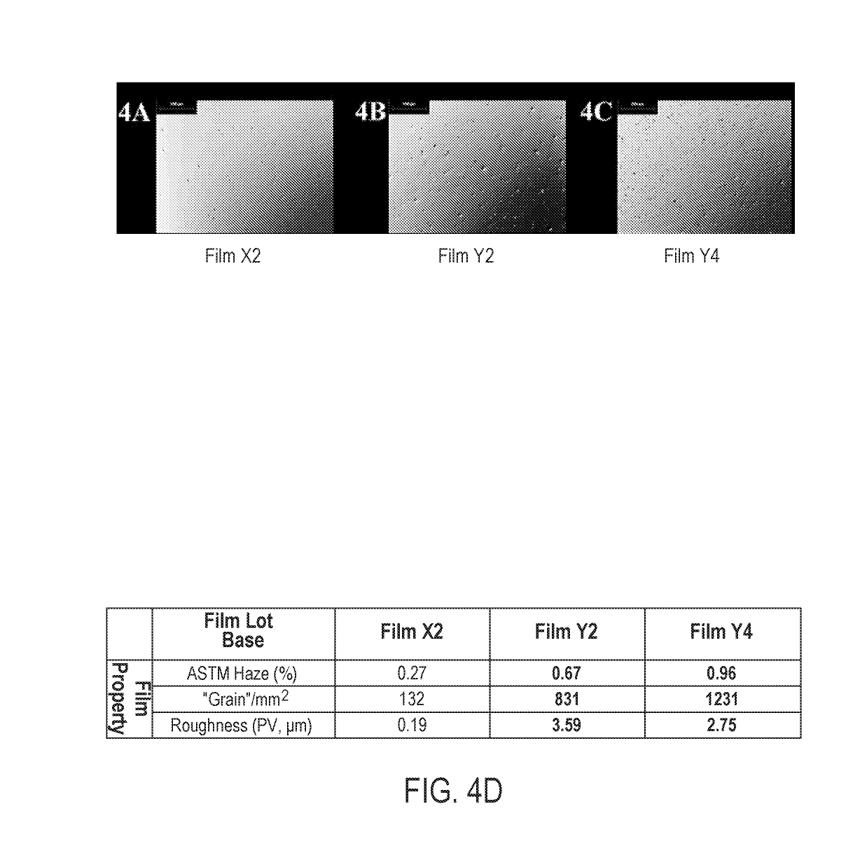

Quantification of the surface feature density (features/mm²) revealed that TN type film had an average value of over 1000 features/mm², whereas the TF type film had an average of 200 features/mm² (FIG. 4D). The number of features/mm² was correlated to haze values of the two films which were measured to be 0.69% versus 0.22% respectively. Further analysis of the surface features identified TAC crystallites as the source of the features. The presence of features may also be attributed to the film extrusion process, where silica is used as an anti-sticking agent.

Due to the higher number of surface features, TN type film is not suitable for the polar lens lamination process. These surface features resulted in high haze values and difficulty in obtaining optical measurements with the SR2.

3. Medium Scale Variations

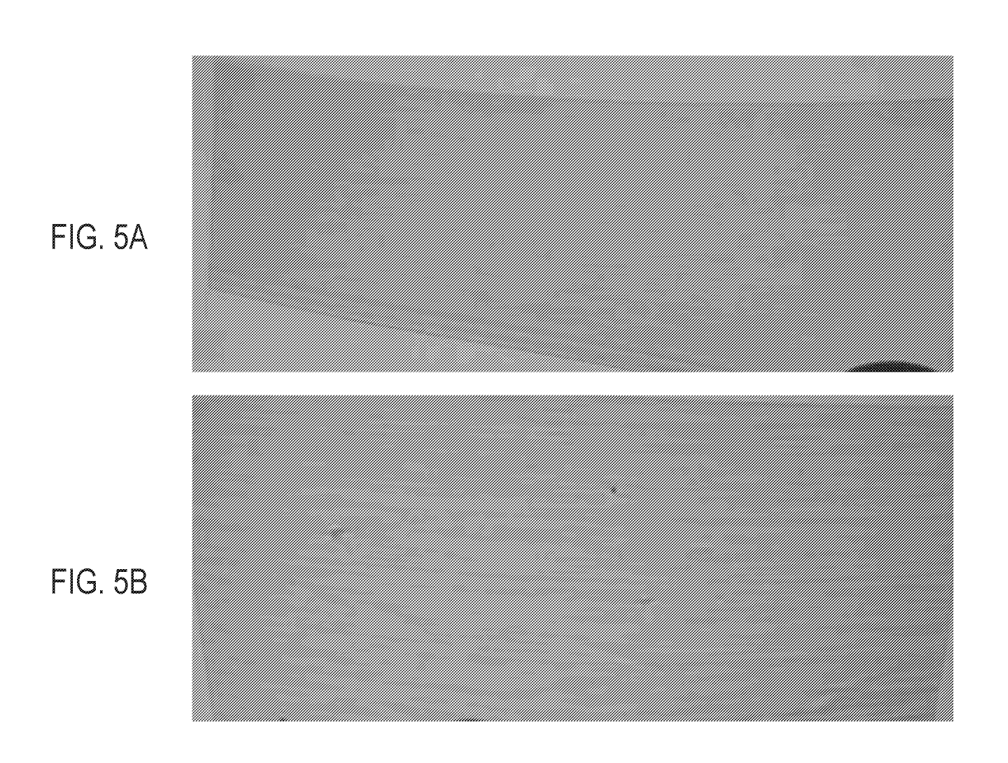

Medium scale level film variations (mm and cm scale) may cause dispersion of optics results, as these variations are on the same scale as the SR2 measurement area. FIGS. 5A and 5B show arc lamp projection images of two different TAC films. The TAC film in FIG. 5A appears uniform, whereas the TAC film in FIG. 5B contains differences in film thickness that are visible to the naked eye.

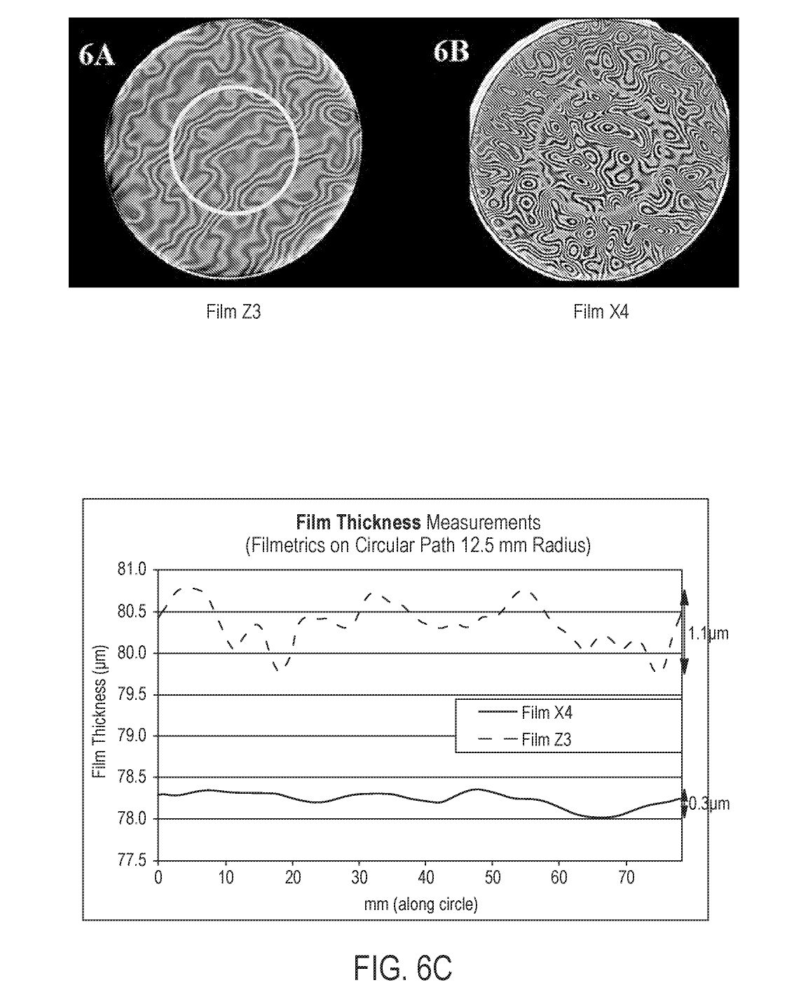

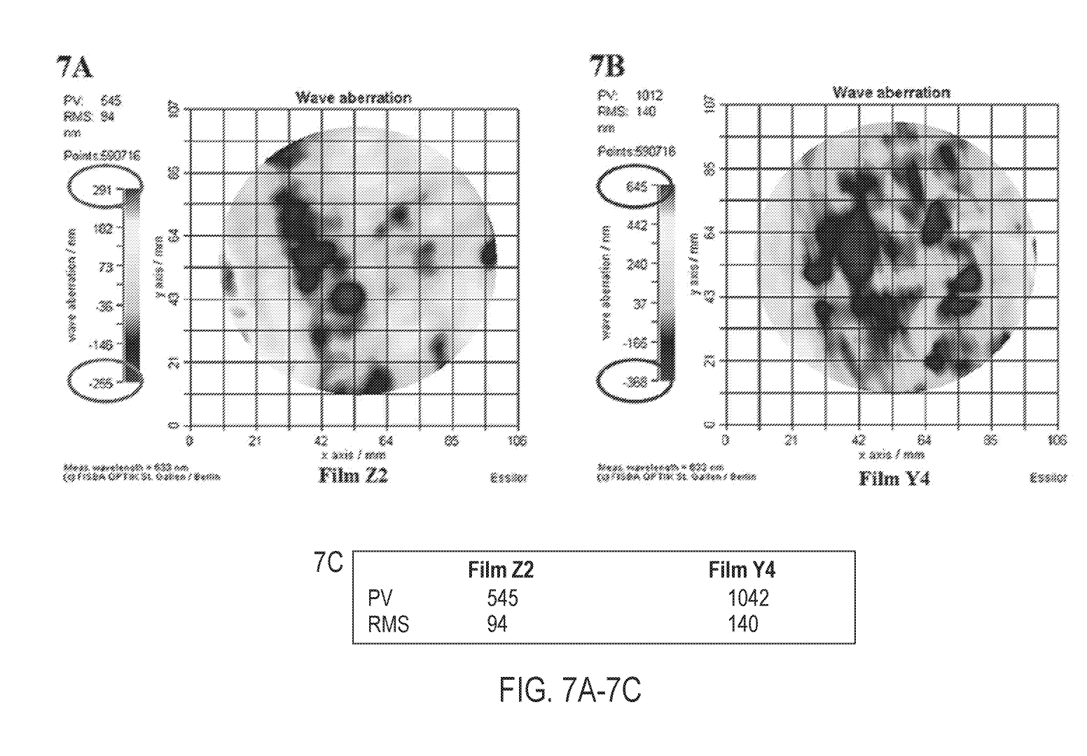

The surface waviness of a TAC/PVA/TAC film laminates were studied by measuring the film thickness variability with Filmetrics (FIG. 6) and FISBA (FIG. 7) monochromatic light interferometers (commercially available from FISBA Optiks). FIGS. 6A and 6B show Filmetrics scans of two different TAC films, Z3 and X4. Clear differences in film thickness variation between films Z3 and X4 are visible. Cross sections taken from the images indicate that magnitude of the film thickness variation of film Z3 is approximately 60% less than that of film X4 (0.3 μm verses 1.1 μm, FIG. 6C). This result was a key factor in the decision to select the production method of film Z3.

FIGS. 7A and 7B depicts FISBA Double pass wave aberration measurements of films Z2 and Y4, respectively using an interferometer that is commercially available from FISBA Optik, Switzerland. The vertical bars to the left of each image illustrate the different scales of the measured wave aberrations. Film Z2 ranges from −255 nm to 291 nm. Film Y4 ranges from −368 nm to 645 nm.

4. Short Scale Variations

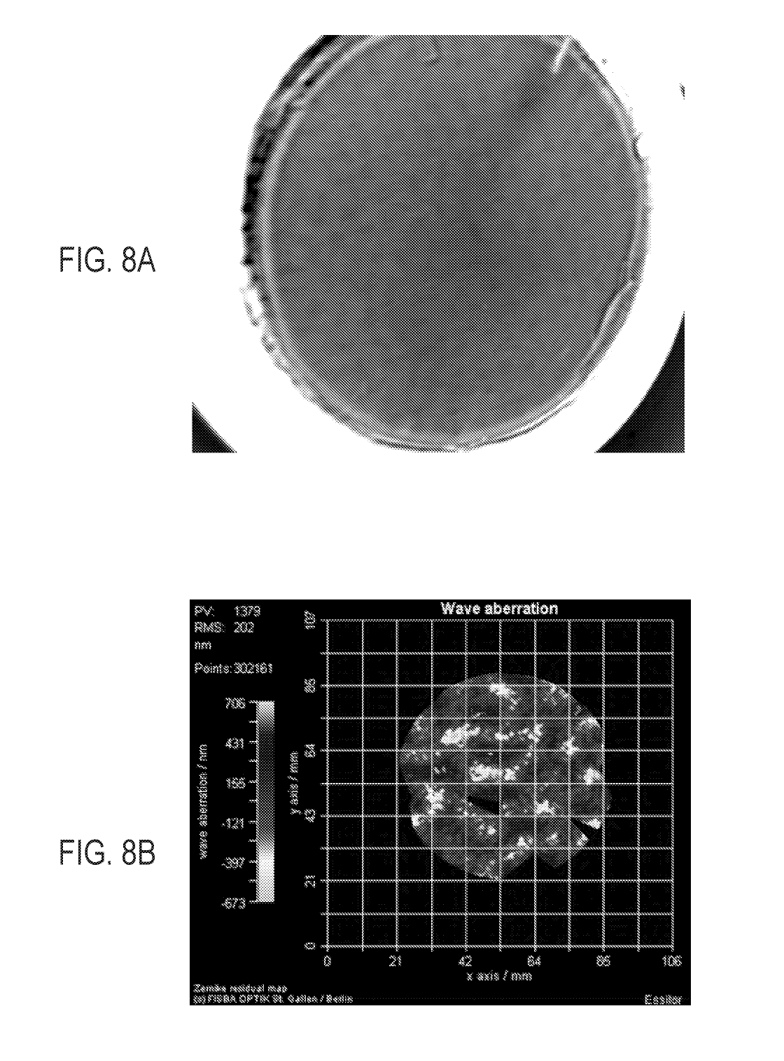

In addition to the TAC film's contribution to the overall optic quality, the polyethylene protective liner has significant effect on the local variations and surface quality of the laminate film. During the evaluation of different test films, an alternative polyethylene protective liner was employed. This alternative film was of lower surface quality, and had a much higher surface waviness, which was transferred to the TAC surface of the laminated film. This was observed as a new type of defect termed a “golf ball” defect. This defect resulted in laminated lenses becoming unreadable with the SR2. Visualization of the defect could be seen on thermoformed wafers in transmission through a Xenon arc lamp (FIG. 8A) and confirmed using FISBA measurements (FIG. 8B).

B. Lens Optics Measurements

1. Optics Measurements using SR2

The Automation Robotics SR2 was used to measure power and cylinder on SFSV lenses uses a center point (PRP) measurement of the radius of curvature of the CX lens surface in reflection.

2. Optics Measurements using DLM

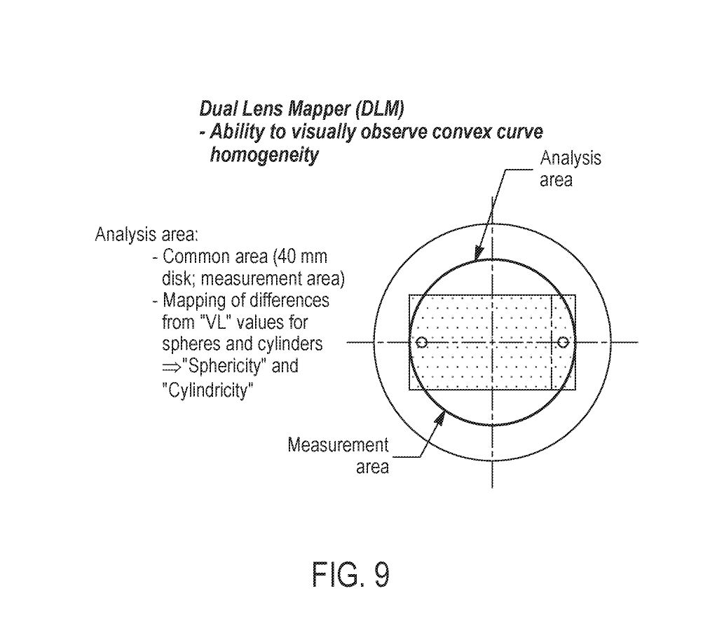

The Automation & Robotics Dual Lens Mapper (DLM) is a method of measuring the local radius of curvature and local cylinder of a CX lens surface. The measurement is that of an array of measurements in an area of 40×30 mm² area instead of single point measurements. This allows for a visualization and assessment of local variations on the CX side of a laminated lens. Illustrative DLM Maps can be constructed from the data as well as point measurements. Values of sphere, cylinder, cylindricity, sphericity, as well as the dispersion of each value and DLM maps were obtained on all critical lamination test lenses. FIG. 9 illustrates the measurement area using the DLM.

The claims are not to be interpreted as including means-plus- or step-plus-function limitations, unless such a limitation is explicitly recited in a given claim using the phrase(s) “means for” or “step for,” respectively.

1.-15. (canceled)

16. An article comprising at least one outer surface, wherein the at least one outer surface comprises a film, said film comprising:
less than 500 features/mm² of micron-scale features; and
a maximum thickness variation of 1 μm and maximum slope of 0.05 μm/mm.

17. The article of claim 16, wherein the film further comprises short scale variations in the z-direction of less than 0.5 μm.

18. The article of claim 17, further comprising short scale variations in the z-direction of less than 0.3 μm.

19. The article of claim 17, further comprising a root mean square (RMS) of short scale variation of less than 250.

20. The article of claim 16 , further comprising an ASTM haze % of less than 0.5.

21. The article of claim 20, further comprising an ASTM haze % of less than 0.3.

22. The article of claim 16, further comprising less than 300 features/mm² of micron-scale features.

23. The article of claim 16, wherein maximum thickness variation is 0.5 μm.

24. The article of claim 16, further comprising a root mean square (RMS) thickness variation of less than 100.

25. The article of claim 16, wherein the film is further defined as a multi-layer laminate film.

26. The article of claim 25, wherein the multi-layer laminate film comprises at least one layer of triacetyl cellulose film.

27. The article of claim 25, wherein the multi-layer laminate film comprises at least one polarizing film layer.

28. The article of claim 27, wherein the at least one polarizing film layer comprises polyvinyl alcohol.

29. The article of claim 27, wherein the at least one polarizing film layer is laminated between layers of triacetyl cellulose film.

30. The article of claim 25, further comprising at least one protective film layer on at least one outer surface.
